(19) United States
(12) Patent Application Publication
(10) Pub. No.: US 2019/0356598 A1
(43) Pub. Date: Nov. 21, 2019

(54) INFORMATION PROCESSING SYSTEM

(71) Applicant: Allied Telesis Holdings K.K., Tokyo (JP)

(72) Inventor: Yohei Kikuchi, Tokyo (JP)

(21) Appl. No.: 16/413,868

(22) Filed: May 16, 2019

(30) Foreign Application Priority Data
May 18, 2018 (JP) 2018-95946

(51) Int. Cl. H04L 12/851; H04L 12/823

(52) U.S. Cl. CPC H04L 47/2483; H04L 47/32

(57) ABSTRACT

There is provided an information processing system using a controller and a switch, wherein the switch transmits a predetermined message to all controllers to be connected when it is determined that there is no flow entry for a packet from a terminal to be connected in a flow table, and the controller sets the flow entry for discarding the packet in the flow table of the switch with low priority when it is determined that the predetermined message received from the switch does not satisfy a predetermined condition.

### CROSS-REFERENCE TO RELATED APPLICATION

This application claims priority under 35 U.S.C. § 119 to Japanese Application No. 2018-95946 filed May 18, 2018, the entire content of which is incorporated herein by reference in its entirety for all purposes.

### FIELD OF ENDEAVOR

The invention relates to an information processing system for controlling a network used in a software defined network (SDN).

### BACKGROUND

Securing network security is becoming an important issue in organizations such as companies and local governments. An organization may perform multiple tasks, but a level of security may vary according to the importance of information to be handled. Therefore, a network handling particularly important information may be required to be separated from other networks.

For example, a local government has been required to separate a network that manages my number from a network that performs business operations, and then block communication between the networks. Therefore, a method of physically separating networks can be considered, but has a heavy burden on network management and the like.

In recent years, the network architecture has become complicated, and in order to facilitate management of the complicated network architecture or a machine configuration, a technique called an SDN may be used (WO2010/103909). OpenFlow in WO2010/103909 is a type of standard specifications of the SDN. Therefore, it is conceivable to logically separate networks using the SDN, instead of physically separating networks of an organization. This is schematically shown in FIG. 9.

In order to introduce an SDN environment into the separated networks, it is necessary to arrange an SDN controller and a switch for each network. Then, an SDN controller is configured to be optimized for each network, and sets, in a flow table, a flow entry for a switch within the network. The flow entry is a rule indicating how to control a packet received from a terminal, and the flow table is a set (table) of flow entries.

In the networks separated using the SDN, the switches should be arranged for each network, and therefore the switches corresponding to the number of networks are required.

However, in the case of arranging the switches corresponding to the number of networks, a plurality of switches should be arranged, and as a result, it is preferable that the plurality of networks can be used by one switch.

If a plurality of SDN controllers managing different networks is configured to use one switch, the switch is located at a boundary between the plurality of networks. However, since the flow entries of each network are simultaneously set in the switch as they are, the operation cannot be achieved as intended. This is schematically shown in FIG. 10.

Thus, JP 2015-154149 A discloses a system that enables one switch to use an SDN controller of a plurality of networks.

### SUMMARY

An object of a system shown in JP 2015-154149 A is to coexist an OpenFlow controller provided by a cloud supplier and an OpenFlow controller which enables own company to perform a control. In this system, when there is a plurality of OpenFlow controllers in the conventional OpenFlow switch, since the flow table is overwritten as it is and the consistency of the network control cannot be maintained, an exclusive control of the flow table is performed to achieve coexistence of the plurality of OpenFlow controllers.

However, in the case of using the system shown in JP 2015-154149 A, when a terminal not registered in any OpenFlow controller is registered in the OpenFlow switch, when a first packet from the terminal is transmitted to the OpenFlow switch, a packet-in message (message indicating that there is no corresponding flow entry in the flow table) is continuously transmitted to all the SDN controllers connected to the switch.

That is, if there is one OpenFlow controller connected to the OpenFlow switch, for packets from terminals not registered in the OpenFlow controller, a flow entry for dropping (discarding packets) can be set in the flow table of the OpenFlow switch. However, if there is a plurality of OpenFlow controllers connected to the OpenFlow switch, it is not a terminal belonging to a network managed by itself, but it may be a terminal belonging to a network managed by another OpenFlow controller, so the flow entry for dropping packets cannot be set in the flow table of the OpenFlow switch. That is, only flow entries that can be processed by itself are set in the flow table. The flow table in this state is shown in FIG. 11. Therefore, the OpenFlow switch continues to transmit packet-in messages to all OpenFlow controllers, which becomes a cause of the increase in the load on the OpenFlow switch and the OpenFlow controller. This is schematically shown in FIG. 12.

In view of the above problems, the present inventor has invented the information processing system that prevents the switch from continuously transmitting the packet-in message even when a new terminal not managed by any SDN controller connected to the switch is registered.

A first invention is an information processing system using a controller and a switch, wherein the switch transmits a predetermined message to all controllers to be connected when it is determined that there is no flow entry for a packet from a terminal to be connected in a flow table, and the controller sets the flow entry for discarding the packet in the flow table of the switch with low priority when it is determined that the predetermined message received from the switch does not satisfy a predetermined condition.

By configuration as in the present invention, when a new terminal not managed by any SDN controller connected to the switch is registered, the processing is executed by the flow entry with low priority for discarding the packet, so it is possible to prevent the switch from continuously transmitting a packet-in message. As a result, the load on the controller or the switch can be reduced.

In the above-described invention, the predetermined condition may be any one of the predetermined message from the registered switch, the predetermined message from the registered port, or the predetermined message for the packet from the terminal for which connection is permitted.

The predetermined condition is preferably set as in the present invention.

In the above-described invention, when the controller determines that the predetermined message received from the switch satisfies a predetermined condition, the flow entry for transmitting the packet to the network controlled by the SDN controller is set in the flow table of the switch with normal priority.

According to the present invention, when the predetermined condition is satisfied, the process may be performed as a normal packet, so the flow entry may be set as the normal priority.

The first invention can also be realized by using the SDN controller of the present invention. That is, the SDN controller used in the network constructed by the SDN is an SDN controller which is receives, from the switch, a message indicating that there is no flow entry for the packet from the terminal connected to the switch in the flow table, and sets the flow entry for discarding the packet in the flow table of the switch with low priority when it is determined that the message received from the switch does not satisfy a predetermined condition.

The first invention can also be realized by using the switch of the present invention. That is, the switch used in the network constructed by an SDN transmits a predetermined message to all the controllers to be connected when it is determined that there is no flow entry for the packet from the terminal to be connected in the flow table, and receives, from the controller, the flow entry with low priority for discarding the packet and sets the received flow entry in the flow table when the controller determines that the message does not satisfy the predetermined condition.

By using the information processing system of the present invention, it is possible to prevent the switch from continuously transmitting the packet-in message even when a new terminal not managed by any SDN controller connected to the switch is registered. As a result, it is possible to reduce the load on the SDN controller or the switch.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 is a diagram showing an example of the entire configuration of an information processing system of the present invention;

FIG. 2 is a diagram showing an example of a hardware configuration of a computer used in the information processing system of the present invention;

FIG. 3 is a flowchart showing an example of a processing process of the information processing system of the present invention;

FIG. 4 is a sequence diagram for a first packet of each terminal in the information processing system of the present invention;

FIG. 5 is a diagram schematically showing an initial state of the flow table;

FIG. 6 is a diagram schematically showing a state in which a flow entry is registered by receiving a packet-in message for first packet from a terminal;

FIG. 7 is a diagram schematically showing a state in which a flow entry is registered by receiving a packet-in message for first packet from a terminal;

FIG. 8 is a diagram schematically showing a state in which a flow entry is registered by receiving a packet-in message for first packet from a terminal;

FIG. 9 is a diagram schematically showing that networks are logically separated using SDN;

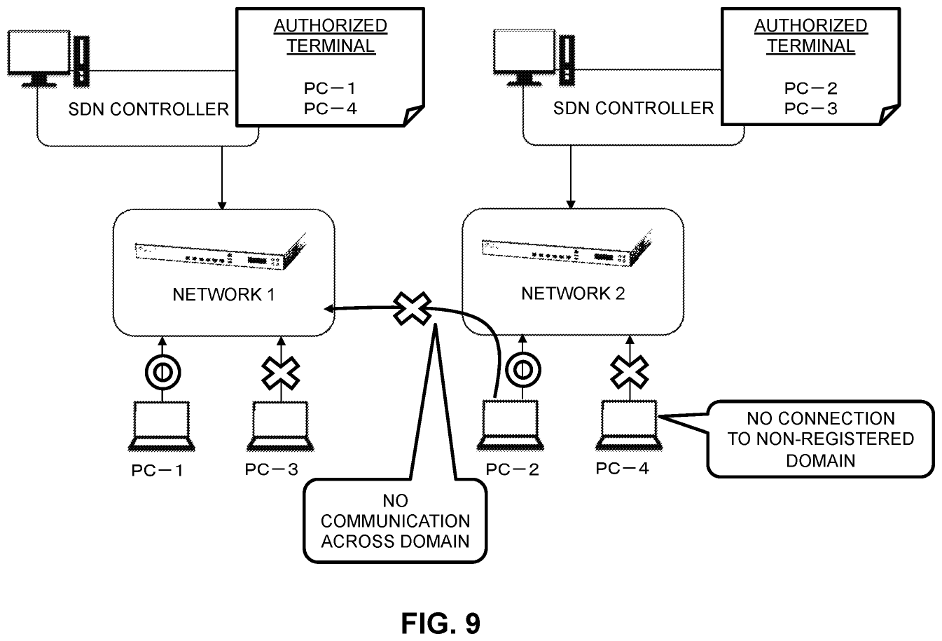

FIG. 10 is a diagram schematically showing a case where an SDN controller managing different networks is connected to one switch;

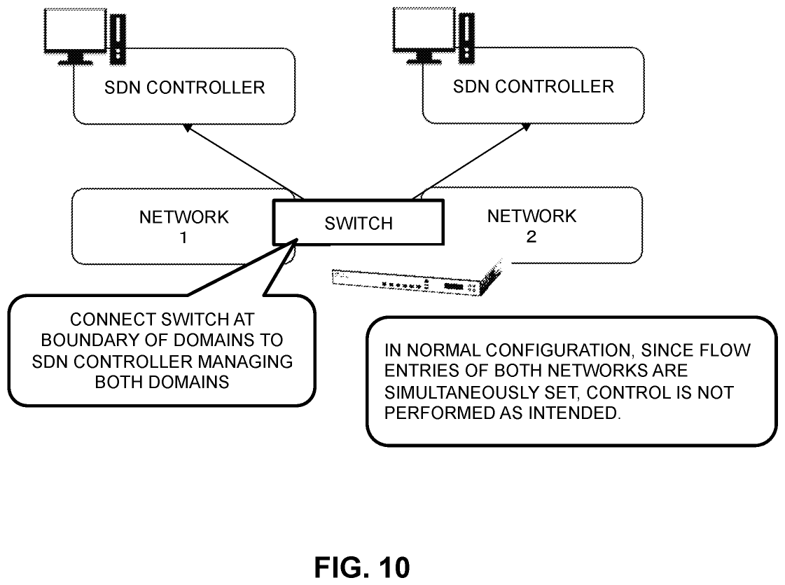

FIG. 11 is a diagram schematically showing a state of the flow table in the conventional example; and

FIG. 12 is a sequence diagram for a first packet of each terminal in the conventional example.

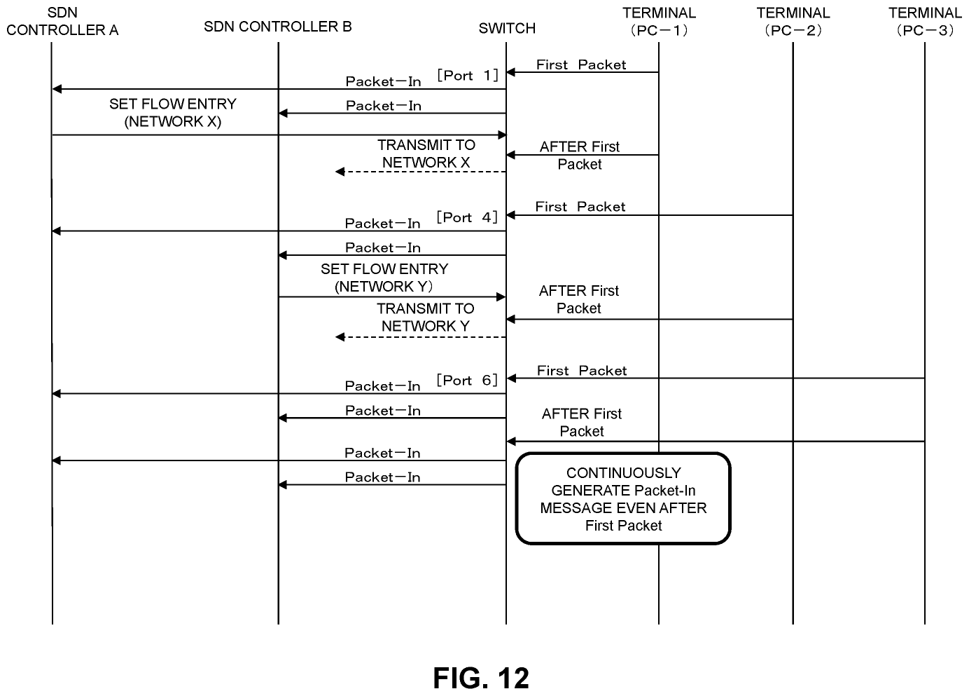

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

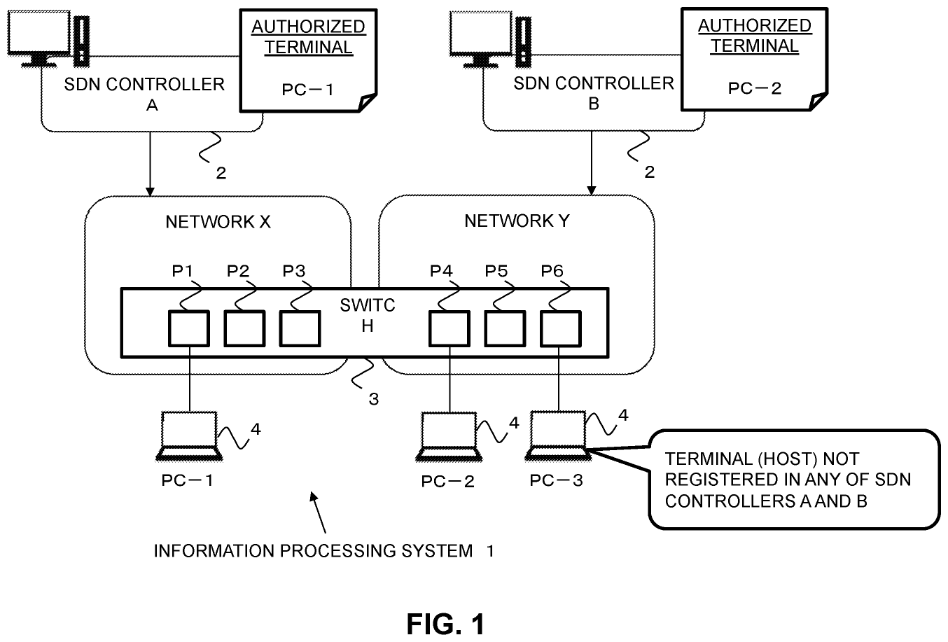

FIG. 1 schematically shows an example of the entire configuration of an information processing system 1 of the present invention. FIG. 1 schematically shows a state in which a plurality of networks (for example, private networks) are constructed using an SDN in an organization such as a company, a government office, or an arbitrary group. An information processing system 1 of the present invention uses an SDN controller 2 and a switch 3 in order to perform network control using an SDN. The switch 3 and a terminal 4 (host) are connected to each network.

In the information processing system 1 of the present invention, a network management technology based on SDN is used, and the communication of one or a plurality of networks is controlled by the SDN controller 2. The SDN controller 2 manages the communication in the network constructed by the SDN, and manages a management unit of the switch 3 at a port level. The SDN controller 2 refers to software for controlling and managing a network and a computer running the software. When OpenFlow is used as the SDN, an OpenFlow controller is the SDN controller 2.

In addition, in the network constructed by the SDN, the terminal 4 is connected via the switch 3. The switch 3 is a network device that transmits data. Although not illustrated, network devices other than the switch 3 necessary for performing network communication, for example, devices such as a gateway are appropriately provided.

The switch 3 stores a set of flow entries (flow table), which is a rule indicating how to control the packet received from the terminal 4, and processes a packet according thereto. A table ID (identification information) for identifying the flow entries, a condition for determining by which of the flow entries for the packet received from the terminal 4 is to be processed, priority and a condition of the flow entry, and a control when the condition is satisfied are stored in the flow table in association with each other.

When the switch 3 receives a first packet from a terminal 4 newly connected, the switch 3 temporarily holds the processing of the packet, and transmits a packet-in message inquiring to all the SDN controllers 2 connected to the switch 3. The SDN controller 2 managing the terminal 4 sets the flow entry for the processing of the packet of the terminal 4 in the flow table of the switch 3. Then, the temporarily held packet is processed based on the flow entry.

The switch 3 in the information processing system 1 of the present invention is connected to the plurality of SDN controllers 2 that manage different networks. When OpenFlow is used as the SDN, an OpenFlow switch corresponds to the switch 3.

FIG. 1 shows a case where the SDN controller 2A controls a network X and the SDN controller 2B controls a network Y using the same switch 3. Ports P1 to P3 of the switch 3 are managed by an SDN controller 2A for managing the network X, and ports P4 to P6 are managed by an SDN controller 2B for managing the network Y. Also, as the authorized terminals 4, a terminal 4 (PC-1) is connected to the port P1, and a terminal 4 (PC-2) is connected to the port P4. A state where a terminal 4 (PC-3) not authorized by any SDN controller 2 is connected to the port P6 is shown.

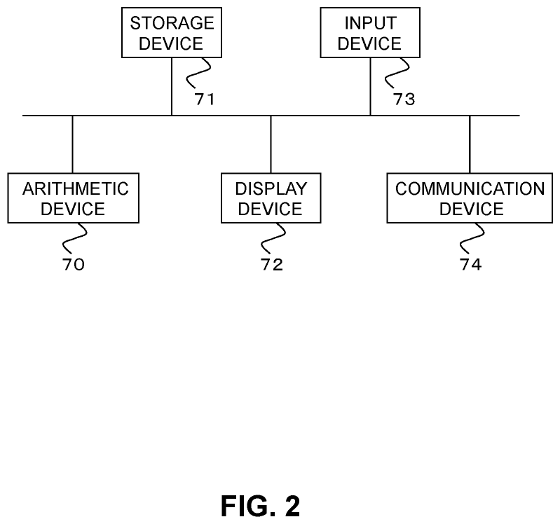

The information processing system 1 of the present invention is realized by various computers such as a server or a personal computer. FIG. 2 shows an example of a hardware configuration of the computer. The computer includes an arithmetic device 70 such as a CPU that executes arithmetic processing of a program, a storage device 71 such as a RAM or a hard disk that stores information, a display device 72 such as a display, an input device 73 such as a keyboard or pointing device (such as a mouse or ten keys), and a communication device 74 that transmits and receives processing results of the arithmetic device 70 or information stored in the storage device 71 via a network such as the Internet or LAN.

Although FIG. 1 shows the case where each processing unit is realized by one computer, the functions thereof may be distributed in a plurality of computers and realized. In addition, each processing unit of this invention may have only logically distinguished functions and may be physically or practically in the same area.

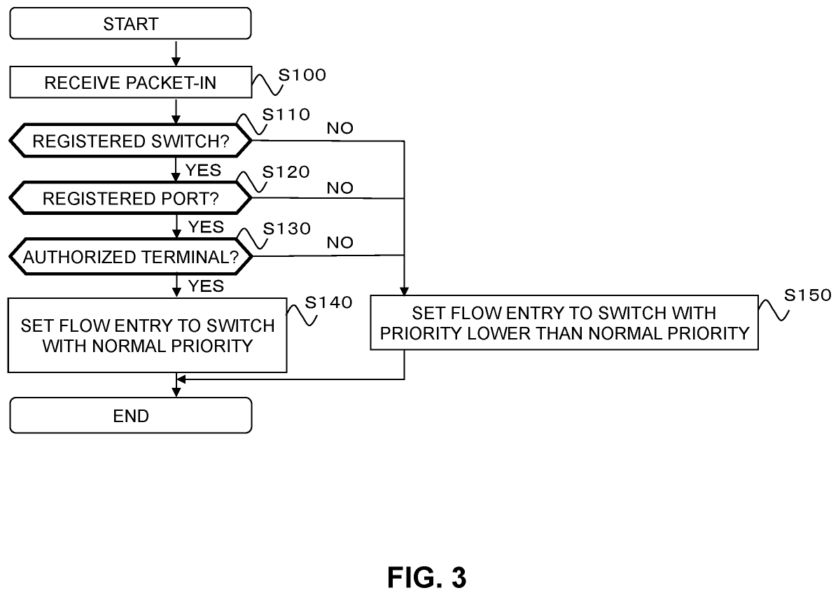

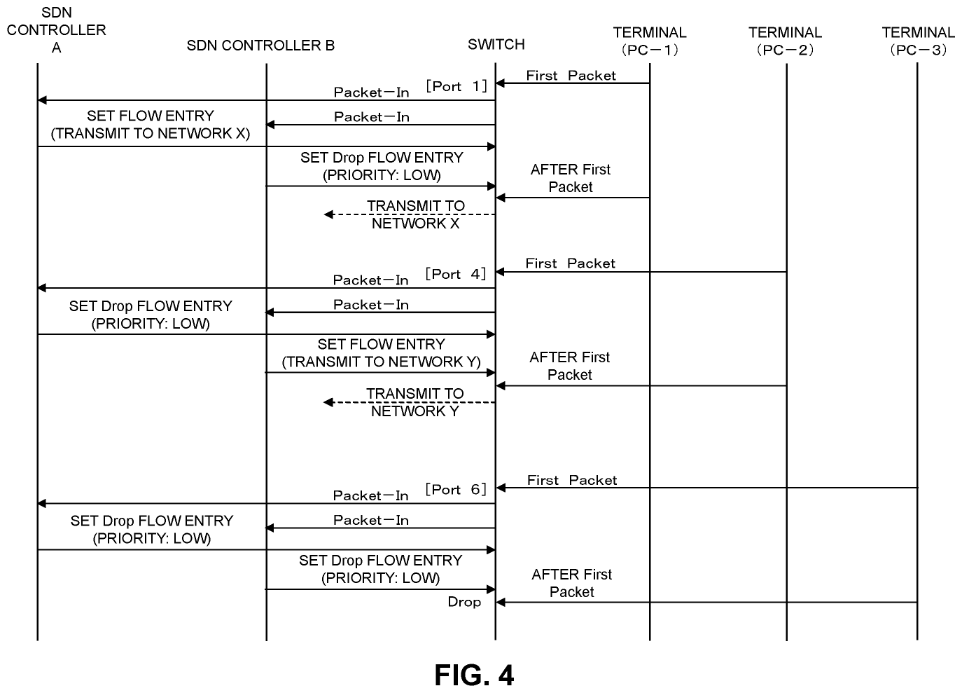

Next, an example of a processing process in the information processing system 1 of the present invention will be described using the flowchart of FIG. 3. FIG. 4 is a diagram showing a sequence diagram for a first packet of each terminal 4 in the information processing system 1 of the present invention.

When the terminal 4 is newly connected to the port of the switch 3 and a first packet from the terminal 4 is received by the switch 3, the switch 3 refers to the flow table of the switch 3. Since the flow entry of the packet of the newly connected terminal 4 is not registered in the flow table, the switch 3 transmits the packet-in message indicating that there is no corresponding flow entry in the flow table to all of the connected SDN controllers 2 (here, the SDN controller 2A and the SDN controller 2B).

Each SDN controller 2 that receives the packet-in message determines whether the packet-in message is a packet-in message from the registered switch 3 (S110), a packet-in message from the registered port (S120), or is a packet-in message for the packet from terminal 4 that is authorized to connect (S130).

That is, when the SDN controller 2 determines that the packet-in message is a packet-in message for a packet from the authorized terminal 4 connected to the registered port of the registered switch 3, the SDN controller 2 sets the flow entry determining which network to connect to switch 3 in the flow table of the switch 3 with normal priority (S140).

On the other hand, when the SDN controller 2 determines that the packet-in message is a packet-in message for a packet from the unregistered switch 3 (S110), from an unregistered port (S120), or from a terminal 4 that is not authorized to connect (S130), for the switch 3, the SDN controller 2 sets a drop flow (flow entry for discarding a packet) with priority lower than the flow entry with normal priority in the flow table of the switch 3 (S150).

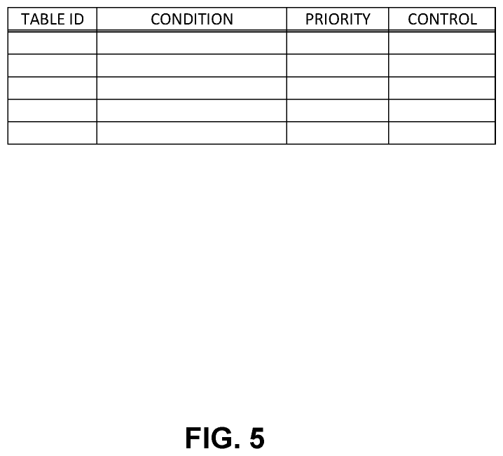

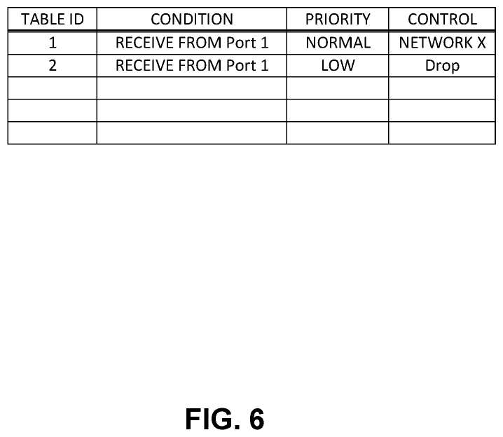

For example, it is assumed that the initial state of the flow table of the switch 3 is as shown in FIG. 5. When the switch 3 receives the first packet from the terminal 4 (PC-1), even if it refers to the flow table, there is no corresponding flow entry, so the switch 3 transmits the packet-in message for the first packet to the SDN controller 2A and the SDN controller 2B. Since the SDN controller 2A determines that the packet-in message is a packet-in message for the packet from the authorized terminal 4 connected to the registered port of the registered switch 3, the flow entry indicating that the packet is transmitted to the network X is set in the flow table of the switch 3. On the other hand, since the SDN controller 2B determines that the packet-in message is not a packet-in message for the packet from the authorized terminal 4 connected to the registered port of the registered switch 3, the drop flow with priority lower than the flow entry with normal priority is registered in the flow table of the switch 3. The flow table of the switch 3 in this state is shown in FIG. 6.

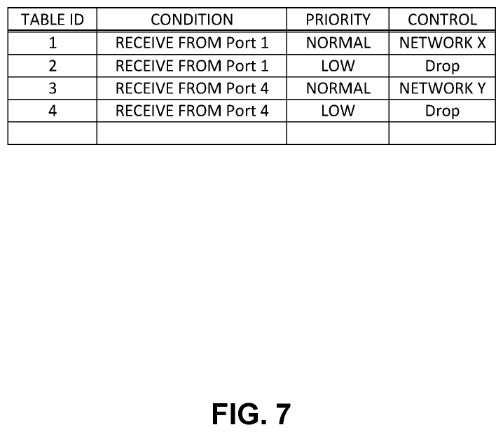

Similarly, when the switch 3 receives the first packet from the terminal 4 (PC-2), even if it refers to the flow table, there is no corresponding flow entry, so the switch 3 transmits the packet-in message for the first packet to the SDN controller 2A and the SDN controller 2B. Since the SDN controller 2B determines that the packet-in message is a packet-in message for the packet from the authorized terminal 4 connected to the registered port of the registered switch 3, the flow entry indicating that the packet is transmitted to the network Y is registered in the flow table of the switch 3. On the other hand, since the SDN controller 2A determines that the packet-in message is not a packet-in message for the packet from the authorized terminal 4 connected to the registered port of the registered switch 3, the drop flow with priority lower than the flow entry with normal priority is set in the flow table of the switch 3. The flow table of the switch 3 in this state is shown in FIG. 7.

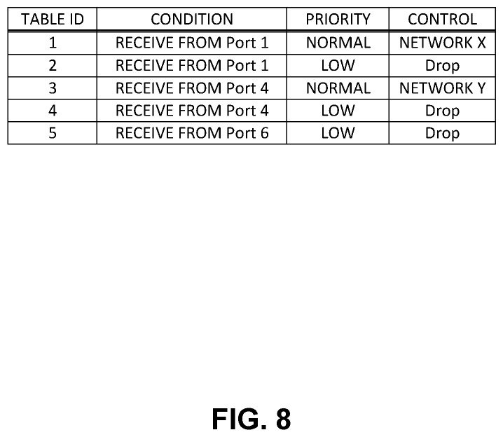

In addition, when the switch 3 receives the first packet from the terminal 4 (PC-3), even if it refers to the flow table, there is no corresponding flow entry, so the switch 3 transmits the packet-in message for the first packet to the SDN controller 2A and the SDN controller 2B. On the other hand, since any of the SDN controller 2A and the SDN controller 2B determines that the packet-in message is not a packet-in message for the packet from the authorized terminal 4 connected to the registered port of the registered switch 3, the drop flow with priority lower than the flow entry with normal priority is set in the flow table of the switch 3. The flow table of the switch 3 in this state is shown in FIG. 8. Since the same flow entry is registered from the SDN controller 2A and the SDN controller 2B, either thereof may be registered, but overlapping registration is not excluded.

The switch 3 that receives the packet after the first packet from the terminal 4 (PC-1) by these processes refers to the flow entry (table ID: 1) of the flow table and executes the flow entry transmitted to the network X with higher priority (normal priority) than the drop flow, so the processing of transmitting the packet to the network X can be executed. In addition, the switch 3 that receives the packet after the first packet from the terminal 4 (PC-2) by these processes refers to the flow entry (table ID: 3) of the flow table and executes the flow entry transmitted to the network Y with higher priority (normal priority) than the drop flow, so the processing of transmitting the packet to the network Y can be executed. When the switch 3 that receives the packet after the first packet from the terminal 4 (PC-3) that is not authorized refers to the flow entry (table ID: 1, 3) of the flow table, there is no corresponding entry in the flow entry with normal priority, but there is a drop flow as a flow entry (table ID: 5) with low priority, so it is possible to execute the drop flow based thereon and execute the processing of discarding the packet.

When the first packet is received from the newly connected terminal 4, the above-described processing is performed to prevent the switch 3 from continuing to transmit the packet-in message when the new terminal 4 not registered in any SDN controller 2 is connected to the switch 3.

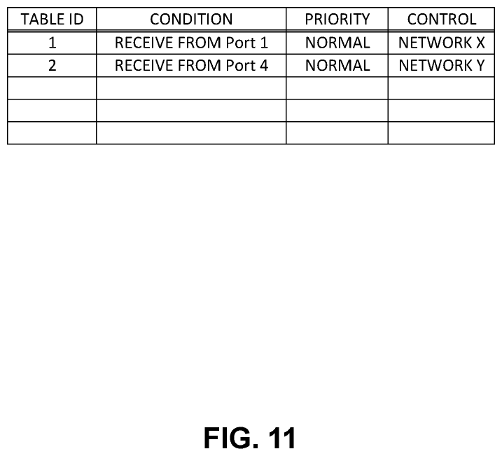

As shown in FIG. 11, in the flow table according to the conventional system, since the flow entry indicating the transmission of the packet from the terminal 4 (PC-1) to the network X and the flow entry indicating the transmission of the packet from the terminal 4 (PC-2) to the network Y are only registered, when the first packet is received from the new terminal 4 (PC-3) which is not registered in any SDN controller 2, the packet-in message is transmitted to all the SDN controllers at all times.

However, when a new terminal 4 not registered in any SDN controller 2 is connected to the switch 3 by using the information processing system 1 of the present invention, the drop flow is set in the flow table with lower priority than the normal priority, so the packet is discarded and the switch 3 does not transmit the packet-in message to the SDN controller 2. Therefore, it is possible to avoid the situation in which the packet-in message is continuously sent.

The above processing is not limited to the case where the first packet is received, but may be executed when an arbitrary packet is received. In addition, when the condition is the same and there is the flow entry of the normal priority and the drop flow with low priority in the flow table, the drop flow with low priority may be deleted.

By using the information processing system 1 of the present invention, it is possible to prevent the switch 3 from continuously transmitting the packet-in message even when a new terminal 4 not managed by any SDN controller 2 connected to the switch 3 is registered. As a result, it is possible to reduce the load on the SDN controller 2 or the switch 3.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1. An information processing system using a controller and a switch, wherein:
the switch transmits a predetermined message to all controllers to be connected when it is determined that there is no flow entry for a packet from a terminal to be connected in a flow table; and
the controller sets the flow entry for discarding the packet in the flow table of the switch with low priority when it is determined that the predetermined message received from the switch does not satisfy a predetermined condition.

2. The information processing system according to claim 1, wherein:
the predetermined condition is one or more of the predetermined message from a registered switch, the predetermined message from a registered port, or the predetermined message for a packet from a terminal that is authorized to connect.

3. The information processing system according to claim 2, wherein:
when the controller determines that the predetermined message received from the switch satisfies a predetermined condition, the flow entry for transmitting the packet to a network controlled by an SDN controller is set in the flow table of the switch with normal priority.

4. An SDN controller used in a network constructed by an SDN, wherein:
the SDN controller receives, from a switch, a message indicating that there is no flow entry for a packet from a terminal connected to the switch in a flow table; and
the SDN controller sets the flow entry for discarding the packet in the flow table of the switch with low priority when it is determined that the message received from the switch does not satisfy a predetermined condition.

5. A switch used in a network constructed by an SDN, wherein
the switch transmits a predetermined message to all controllers to be connected when it is determined that there is no flow entry for a packet from a terminal to be connected in a flow table;
the switch receives, from the controller, a flow entry with low priority for discarding the packet when the controller determines that the message does not satisfy a predetermined condition; and
the switch sets the received flow entry in the flow table.
